(19) United States
(12) Patent Application Publication
(10) Pub. No.: US 2020/0116137 A1
(43) Pub. Date: Apr. 16, 2020

(54) MOBILE THICK MATTERS PUMP

(71) Applicant: Schwing GmbH, Herne (DE)

(72) Inventors: Rudolf Rabsahl, Dortmund (DE); Boris Streier, Recklinghausen (DE)

(21) Appl. No.: 16/599,512

(22) Filed: Oct. 11, 2019

(30) Foreign Application Priority Data
Oct. 11, 2018 (DE) 10 2018 125 163.7

(51) Int. Cl. F04B 15/02; F04B 53/16; F04B 17/06

(52) U.S. Cl. CPC F04B 15/02; B60Q 1/30; F04B 17/06; F04B 53/16

(57) ABSTRACT

A mobile thick matters pump for conveying thick matters is disclosed. The mobile thick matters pump includes a chassis, a pump unit arranged on the chassis, a charging hopper including an upper filling opening and configured to charge thick matters, a cover that is pivotable, and a rear light assembly arranged on the cover and pivotable together with the cover.

### CROSS-REFERENCE TO RELATED APPLICATION

This application hereby claims the benefit of German Application No. DE 10 2018 125 163.7, filed Oct. 11, 2018, which is herein incorporated by reference in its entirety.

### TECHNICAL FIELD

The invention relates to a mobile thick matters pump for conveying thick matters, with a chassis, a pump unit arranged on the chassis, a charging hopper, open at the top, for charging thick matters which are to be conveyed, a pivotable cover, wherein the cover in a closure pivoted position closes the upper filling opening of the charging hopper and in an opening pivoted position uncovers the filling opening of the charging hopper, and with a rear light assembly.

### BACKGROUND

Thick matters pumps known from the prior art have rear light assemblies coupled rigidly to the chassis, which comprise for example a rear light oriented permanently in a particular position in relation to the chassis. What is problematic about the rigid rear-light holders known from the prior art is that they mostly project out from the contour of the chassis. In construction-site operation, such holders are susceptible to damage due to collisions.

Pivotable, hinged or adjustable devices are also known from the prior art for protecting the rear light assemblies better from collisions in construction-site operation, while the rear light assemblies in road operation are positioned as wide or as far to the outside as possible. Such a device is known for example from DE 20 2016 007 988 U1. What is disadvantageous about the solution described here is that the rear light assembly in construction-site operation is arranged beneath the charging hopper and hence in a region which readily becomes soiled when charging thick matters which are to be conveyed. Furthermore, the rear light assembly in construction-site operation continues to be located in a region in which damage can easily be caused when backing truck mixers up to the charging hopper. Thus the rear light assembly when charging thick matters which are to be conveyed, in particular concrete, is easily damaged or fouled, and further is in the way, which may furthermore lead to collisions.

The object of the invention is therefore to devise an improved thick matters pump which makes a simple and safe arrangement of the rear light assembly possible in construction-site operation. In particular, damage to and fouling of the rear light assembly when charging thick matters which are to be conveyed into the charging hopper by way of the upper filling opening thereof is to be avoided.

### SUMMARY

This object is achieved by a thick matters pump having the features of the claims.

Due to the fact that the rear light assembly is arranged on the pivotable cover and is designed to be pivotable together with the cover, a safe arrangement of the rear light assembly when charging into the charging hopper thick matters which are to be conveyed can be made possible in a simple manner. To this end, the rear light assembly on the pivotable cover is pivoted together therewith. Thus the rear light assembly on the construction site during pumping operation of the thick matters pump is not in the way during the charging into the charging hopper of thick matters which are to be conveyed. In the opening pivoted position of the cover, the rear light assembly is pivoted along with it, so that it is not soiled by thick matters when charging into the charging hopper. By way of the pivoting of the rear light assembly together with the pivotable cover, a safe position for the rear light assembly can be set particularly simply.

The rear light assembly is preferably formed by two red reflectors. Furthermore, the rear light assembly preferably comprises two direction indicators, which further are preferably designed as yellow flashing signal lights. In addition, the rear light assembly may comprise two red tail lights which indicate the end of the vehicle. Moreover, the rear light assembly may have two brake lights which indicate braking of the vehicle. Moreover, the rear light assembly may comprise reversing lights, rear fog lamps and a number-plate light.

Advantageous configurations and developments of the invention will become apparent from the dependent claims. It should be pointed out that the features listed individually in the claims may also be combined with one another in any technologically sensible manner whatsoever and thus reveal further configurations of the invention.

According to one advantageous configuration of the invention, provision is made for the rear light assembly in the closure pivoted position of the cover to be oriented counter to the direction of travel of the chassis. With the orientation of the rear light assembly in the closure pivoted position counter to the direction of travel of the chassis, the end of the chassis can be perceived safely by road users following behind even at dusk, during the hours of darkness or in poor weather conditions. The orientation of the rear light assembly is set by the main direction of beam of the lights forming the rear light assembly, which lights in the closure pivoted position of the cover shine mainly counter to the direction of travel of the chassis.

Particularly preferred is an embodiment which provides for the cover to be pivotably articulated in the region of its edge which is on the direction-of-travel side, so that it is pivoted upwards in the direction of travel out of the closure pivoted position, in which the cover is oriented substantially horizontally, into the opening pivoted position, in which the cover is oriented substantially vertically. With the opening of the pivotable cover, the rear light assembly can be brought simply into a position to the front above the charging hopper, where the rear light assembly is safe from soiling and damage during the charging into the charging hopper of thick matters which are to be conveyed.

One particularly advantageous embodiment of the invention relates to the rear light assembly being fastened to the cover by way of a subframe. With the fastening of the rear light assembly by way of the subframe, the arrangement of the rear light assembly can take place independently of the shape of the cover. Thus legal stipulations for the arrangement of the rear light assembly can be met simply and independently of the configuration of the cover and the charging hopper.

One particularly advantageous embodiment of the invention provides for the subframe to project beyond the width of the cover transversely to the direction of travel of the chassis, and for the rear light assembly to be arranged, offset at least partially in the direction of travel of the chassis, on the subframe laterally next to the cover. In the case of particularly wide vehicles, such as truck-mounted concrete pumps, it may be necessary to arrange the rear light assembly, partially in the direction of travel of the chassis, on the frame laterally next to the cover in order to comply with the legal maximum distance of for example the flashing signal light and tail light from the outside of the vehicle. In this manner, parts of the rear light assembly can be arranged very simply independently of the shape of the cover and of the charging hopper in the direction of travel laterally next to the latter.

One advantageous embodiment of the invention provides for a working light to be arranged on the cover, which light in the opening pivoted position of the cover illuminates the charging hopper from above. With such a working light, in the opening pivoted position of the cover the charging hopper, the upper filling opening thereof and the region around the charging hopper can be illuminated sufficiently so that it is possible to work safely even at dusk or in darkness.

### BRIEF DESCRIPTION OF THE DRAWINGS

Further features, details and advantages of the invention will become apparent on the basis of the following description and with reference to the drawings, which show examples of embodiment of the invention. Objects or elements which correspond to one another are provided with the same reference numerals in all the figures. These show:

FIG. 1 thick matters pump according to the invention,

FIG. 2 thick matters pump with opened cover,

FIG. 3 rear view of the thick matters pump,

FIG. 4 side view of the thick matters pump, and

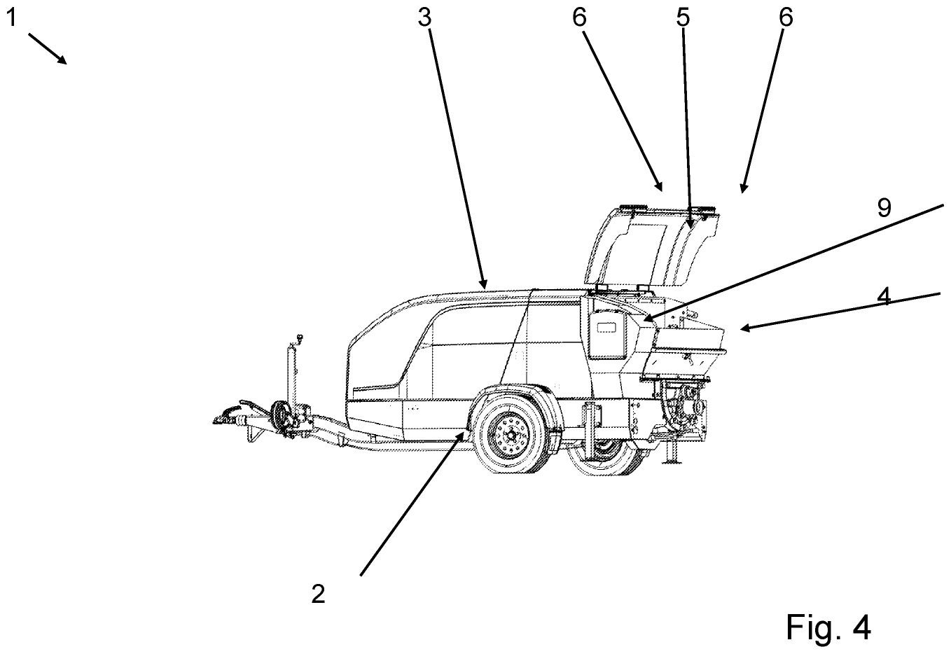

FIG. 5 detail view of cover

FIG. 6 side view of the closed cover

### DETAILED DESCRIPTION

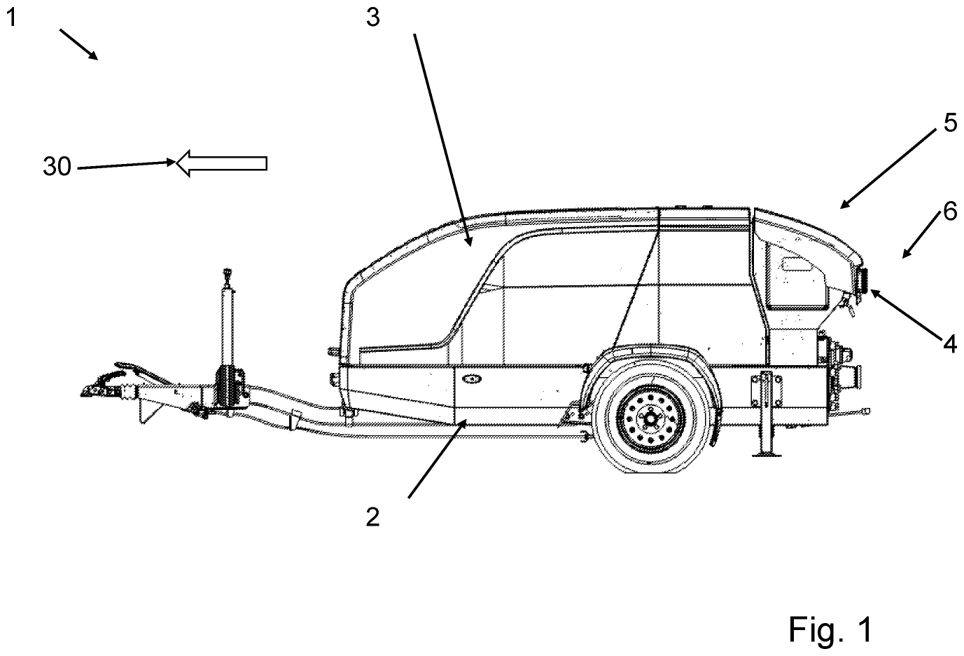

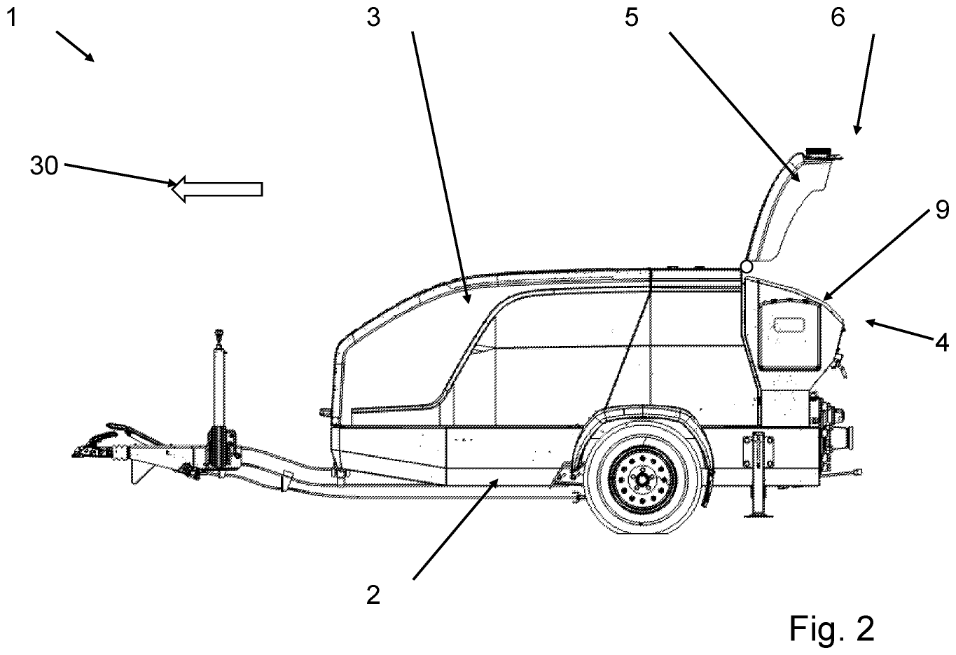

In FIG. 1, a thick matters pump according to the invention is illustrated, designated by the reference numeral 1. The thick matters pump 1 has a chassis 2 of a trailer. On this chassis 2 there is arranged a pump unit 3. This pump unit 3 is supplied with thick matters which are to be conveyed by way of a charging hopper 4 which is arranged at the rear of the chassis 2. The charging hopper 4 arranged on the rear side of the chassis 2 has a pivotable cover 5, with which an upper filling opening of the charging hopper 4 can be closed in a closure pivoted position, as can be seen in FIG. 1. In an opening pivoted position, which is shown in FIG. 2, the filling opening of the charging hopper 4 can be uncovered by the cover 5 for charging thick matters which are to be conveyed. The thick matters pump 1 has a rear light assembly 6 arranged at the rear. This rear light assembly 6 is arranged according to the invention on the pivotable cover 5 and, as can be seen from FIG. 2, is pivoted together with the cover 5. Thus the rear light assembly 6 in the closure pivoted position of the cover 5 according to FIG. 1 is in an orientation counter to the direction of travel 30 indicated by the block arrow. With this orientation counter to the direction of travel 30 of the chassis 2, the rear light assembly 6 is readily visible to road users following behind.

FIG. 2 shows the thick matters pump 1 according to FIG. 1, with the cover 5 here being pivoted forwards and upwards in the opening pivoted position. The rear light assembly 6 pivoted with the cover 5 in this position is located above the charging hopper 4. As a result, soiling of the rear light assembly 6 when charging into the charging hopper 4 thick matters which are to be conveyed is avoided in simple manner.

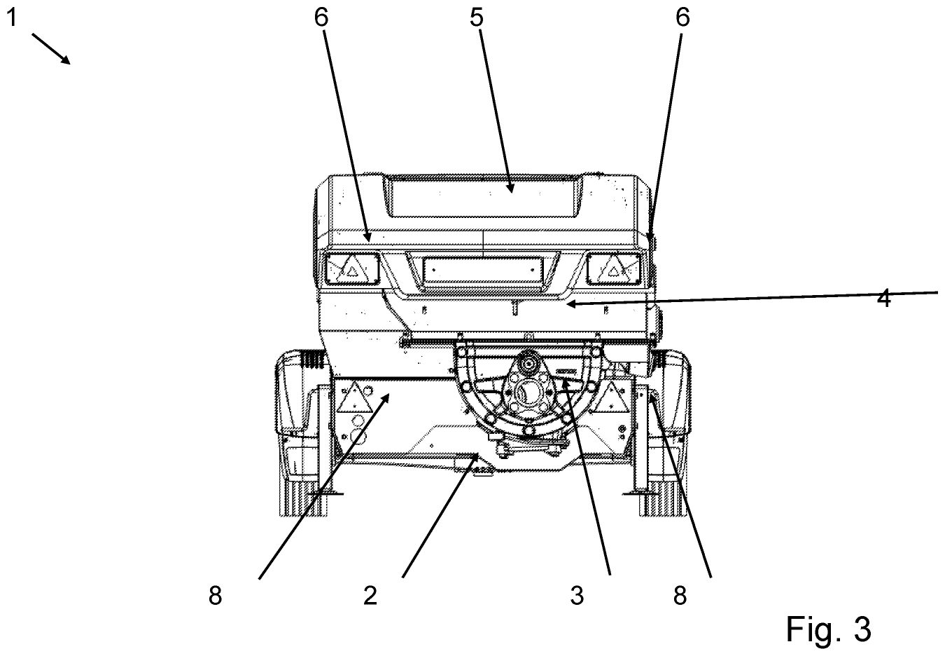

In FIG. 3, a rear view of the thick matters pump 1 of FIGS. 1 and 2 can be seen. In this illustration, it can readily be recognized that the rear light assembly 6 arranged on the pivotable cover 5 comprises two direction indicators, two tail lights, two brake lights and reversing lights, rear fog lamps and a number-plate light. The charging hopper 4 lies approximately eccentrically, e.g., offset to the right when viewed from the rear, and the pivotable cover 5 is somewhat wider than the charging hopper and simultaneously covers a document container 9 when the cover 5 is closed, as can be seen from FIGS. 1 and 2. In the case of wider vehicles, such as truck-mounted concrete pumps, these lights of the rear light assembly 6 are preferably fastened to a subframe, not illustrated, angled pieces or similar, which is/are arranged on the cover 5, or the entire cover 5 is made correspondingly wider, in particular wider than the charging hopper 4, in order to comply with the specifications for the arrangement of the rear lights. Furthermore, two reflectors (retroreflectors) 8 are arranged at the rear of the thick matters pump 1, which reflectors are not pivoted together with the cover 5. As a result, they continue to be readily visible even when the cover 5 is pivoted into the opening pivoted position.

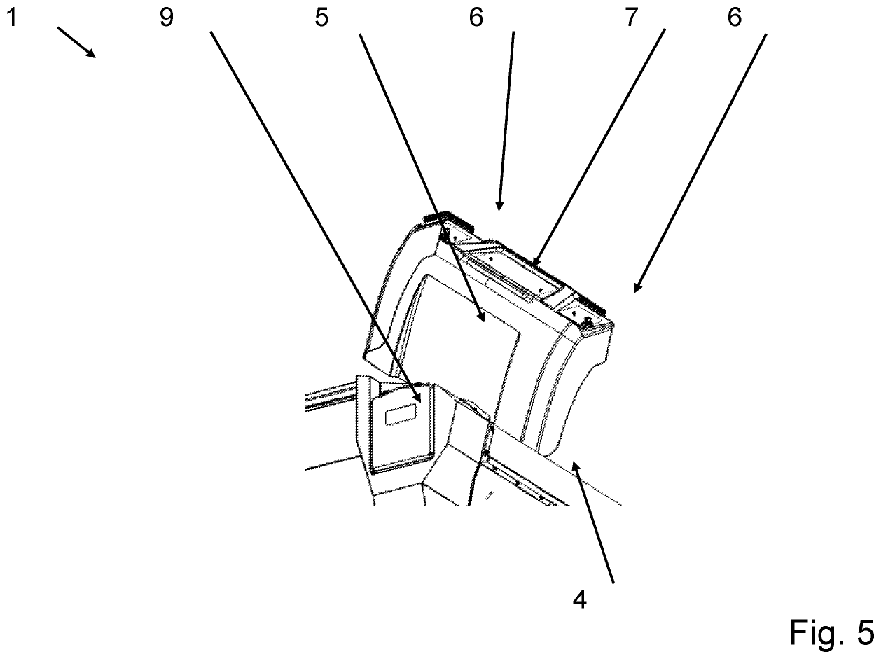

FIG. 5 illustrates a detail view of the cover 5 in the opening pivoted position. In this illustration, the view of the working light 7 arranged in the cover 5, which light illuminates the charging hopper 4, the upper filling opening thereof and the region around the charging hopper 4 from above at dusk and in darkness, is clear.

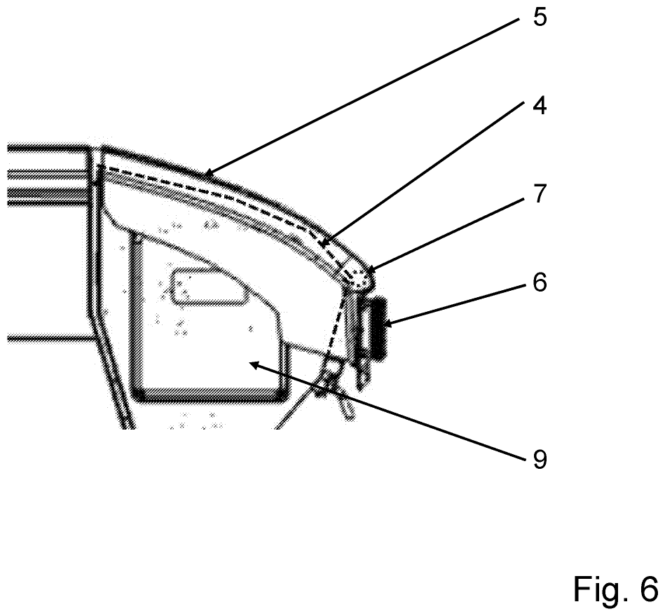

As can be seen from FIG. 6, the cover 5 is embodied such that the working light 7 when the cover 5 is closed is not arranged directly above the charging hopper 4, but somewhat behind it. This avoids the working light 7 being fouled during pum ping-back of the thick matters, which preferably takes place with the cover 5 closed. For this, the cover 5 projects somewhat rearwards beyond the charging hopper 4.

### LIST OF REFERENCE NUMERALS

1 mobile thick matters pump
2 chassis
3 pump unit
4 charging hopper
5 cover
6 rear light assembly
7 working light
8 reflectors
9 document container
30 direction of travel

We claim:

1. A mobile thick matters pump for conveying thick matters, comprising:
a chassis;
a pump unit arranged on the chassis;
a charging hopper including an upper filling opening and configured to charge thick matters;
a cover that is pivotable, wherein the cover in a closed pivoted position closes the upper filling opening of the charging hopper and in an opened pivoted position uncovers the upper filling opening of the charging hopper; and
a rear light assembly arranged on the cover and pivotable together with the cover.

2. The mobile thick matters pump of claim 1, wherein the rear light assembly in the closed pivoted position is oriented counter to a direction of travel of the chassis.

3. The mobile thick matters pump of claim 1, wherein the cover is pivotable along an edge on a direction-of-travel side of the chassis such that the cover is pivoted upwards in the direction of travel from the closed pivoted position, in which the cover is oriented substantially horizontally, to the opened pivoted position, in which the cover is oriented substantially vertically.

4. The mobile thick matters pump of claim 1, wherein the rear light assembly is fastened to the cover via a subframe.

5. The mobile thick matters pump of claim 4, wherein the subframe projects beyond a width of the cover transversely to a direction of travel of the chassis.

6. The mobile thick matters pump of claim 5, wherein the rear light assembly is arranged, offset at least partially in the direction of travel of the chassis, on the subframe laterally next to the cover.

7. The mobile thick matters pump of claim 1, wherein a working light is arranged on the cover such that, in the opened pivoted position, the working light illuminates the charging hopper from above.
